(19) United States
(12) Patent Application Publication
(10) Pub. No.: US 2019/0349488 A1
(43) Pub. Date: Nov. 14, 2019

(54) IMAGE PROCESSOR AND PROGRAM

(71) Applicant: Konica Minolta, Inc., Tokyo (JP)

(72) Inventor: Bounta Chitpasong, Toyokawa-shi, Aichi (JP)

(73) Assignee: Konica Minolta, Inc., Tokyo (JP)

(21) Appl. No.: 16/404,866

(22) Filed: May 7, 2019

(30) Foreign Application Priority Data
May 14, 2018 (JP) 2018-093209

(51) Int. Cl. H04N 1/00

(52) U.S. Cl. CPC H04N 1/00403; H04N 2201/0094; H04N 1/0097; H04N 1/00488

(57) ABSTRACT

An image processor includes: a hardware processor that receives an instruction for setting an operation condition of a job issued by voice of a user via a voice input device, and sets the operation condition based on the instruction; and a storage that stores one or more default values regarding the operation condition, and a changed content when at least one of the default values is changed. The hardware processor further: causes, before execution of the job, a voice output device to output a voice confirmation message that includes a content of the instruction; determines, before the execution of the job, whether at least one of the default values is changed; and when a default value among the one or more default values is changed, causes the voice output device to output the changed content of the default value in the voice confirmation message.

### CROSS-REFERENCE TO RELATED APPLICATIONS

The entire disclosure of Japanese patent Application No. 2018-093209, filed on May 14, 2018, is incorporated herein by reference in its entirety.

### BACKGROUND

### Technological Field

The present invention relates to an image processor such as a copier, a printer, and a multifunctional digital complex machine called a multi-function peripheral (MFP), and a program.

### Description of the Related Art

As an image processor as described above, there has been conventionally known a device capable of instructing setting of an operation condition of a job via a voice input device capable of inputting voice, such as a microphone, using user's voice.

When the instruction for setting an operation condition of a job is issued by voice input, generally, not all of the operation conditions are instructed but only a part of the operation conditions is input by voice, and a default value is adopted for an operation condition that has not input by voice.

When the image processor sets the operation condition in accordance with the setting instruction by voice input, a voice message including contents of the operation condition instructed to be set is output via a voice output device such as a speaker prior to execution of the job so that the user confirms the contents. For example, when an instruction by voice is “Two copies.”, a voice message such as “Is it two copies?” is output from the voice output device.

The default value of the operation condition of the job is not necessarily a fixed value at all times, and it may be changed by, for example, an administrator or another user, afterward.

However, conventionally, the default value is adopted for the operation condition that the user has not issued a setting instruction as described above, and this default value does not include a message for confirming the operation condition, whereby the job is executed while the user does not notice the changed default value so that the execution result intended by the user cannot be obtained and erroneous copying or the like occurs.

In addition, the default value may not be used due to a state of its own device in some cases. For example, there is a case where no A4 size paper sheet is stored in a paper feed tray when the A4 size paper sheet is the default value. In this case, the user does not notice that the default value cannot be used and the job is executed with another paper size so that the execution result intended by the user cannot be obtained.

In JP 2011-66500 A, there is disclosed an image processor that aims to facilitate setting regarding image forming operation and image reading operation and to reduce erroneous setting caused by inadvertence. In the image processor, a control unit 13 calculates a usage frequency of the setting related to the image forming operation stored in a setting storage 12, and when a setting different from the setting in which the calculated usage frequency is high is detected, information prompting confirmation of the setting is output to the outside using an announcement output unit 15 before an image former 14 executes the image forming operation. Further, a usage frequency of the setting related to the image reading operation stored in the setting storage 12 is calculated, and when a setting different from the setting in which the calculated usage frequency is high is detected, information prompting confirmation of the setting is output to the outside using the announcement output unit 15 before an image reader executes the image reading operation.

Besides, JP 2007-140376 A discloses an image processor that aims to efficiently and exhaustively output voice information regarding setting content necessary for a user to prevent erroneous setting caused by the user forgetting to change setting or the like. The image processor includes a setting changer 101 that changes a plurality of preset setting values on the basis of instruction input operation, a setting change detector 102 that detects the setting change, a voice output priority level determiner 103 that determines a priority level of outputting setting information by voice on the basis of the detection result of the setting change, and a voice output device 104 that outputs the setting information by voice according to the priority level.

However, according to JP 2011-66500 A and JP 2007-140376 A, when an instruction for setting an operation condition of a job is issued by voice input, the job is executed while the user does not notice the changed default value or an unusable default value so that the execution result intended by the user cannot be obtained.

### SUMMARY

In one or more embodiments of the present invention, in the image processor that issues a setting instruction of an operation condition of a job by voice input, an execution result of the job intended by a user cannot be obtained when a default value has been changed or a default value cannot be used due to a state of the image processor.

In one or more embodiments of the present invention, an image processor comprises: a receiver that receives an instruction for setting an operation condition of a job issued by voice of a user via a voice input device capable of inputting voice; a setter that sets the operation condition of the job in accordance with the instruction for setting the operation condition of the job received by the receiver; a storage that stores one or a plurality of default values regarding the operation condition of the job, and also stores changed content when at least one of the default values is changed; a hardware processor that causes a voice output device to output a voice confirmation message including content of the instruction for setting the operation condition of the job received by the receiver before execution of the job; and a determiner that determines whether at least one of the default values is changed before the execution of the job, wherein when the determiner determines that the default value is changed, the hardware processor causes the voice output device to output the message including the changed content of the default value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a configuration diagram of an image processing system in which an image processor according to one or more embodiments of the present invention is used.

FIG. 2 is a block diagram illustrating configurations of the image processor and an audio terminal in the image processing system illustrated in FIG. 1.

FIG. 3 is an explanatory diagram for illustrating a state in which jobs and default values related to operation conditions of the jobs are stored in a storage of the image processor, in accordance with one or more embodiments.

FIG. 4 is an explanatory diagram for illustrating a state in which the default values illustrated in FIG. 3 are changed.

FIG. 5 is an explanatory diagram in the case where a user has issued an instruction for setting an operation condition by voice input without knowing that the default value has been changed, in accordance with one or more embodiments.

FIG. 6 is an explanatory diagram of a state in which a confirmation message is uttered, in accordance with one or more embodiments.

FIG. 7 is an explanatory diagram of a state in which the user who had heard the message of FIG. 6 has once again issued a setting instruction by voice input.

FIG. 8 is an explanatory diagram of a state in which a confirmation message is uttered again, in accordance with one or more embodiments.

FIG. 9 is an explanatory diagram of a state in which voice input for instructing job execution is performed, in accordance with one or more embodiments.

FIG. 10 is a flowchart illustrating a process of storing a default value performed by the image processor, in accordance with one or more embodiments.

FIG. 11 is a flowchart illustrating operation of the image processor that has received the instruction for setting the operation condition of the job made by the user's voice, in accordance with one or more embodiments.

FIG. 12 is a diagram illustrating that the remaining number of A4 paper sheets, which is the default value of a paper size of a copy job, is zero, in accordance with one or more embodiments.

FIG. 13 is an explanatory diagram of a state in which a confirmation message is uttered, in accordance with one or more embodiments.

FIG. 14 is an explanatory diagram of a state in which a confirmation message is uttered again, in accordance with one or more embodiments.

FIG. 15 is an explanatory diagram of a state in which voice input for instructing job execution is performed, in accordance with one or more embodiments.

FIG. 16 is another flowchart illustrating the process of storing a default value performed by the image processor, in accordance with one or more embodiments.

FIG. 17 is another flowchart illustrating the operation of the image processor that has received the instruction for setting the operation condition of the job made by the user's voice, in accordance with one or more embodiments.

### DETAILED DESCRIPTION

Hereinafter, embodiments of the present invention will be described with reference to the drawings. However, the scope of the invention is not limited to the disclosed embodiments.

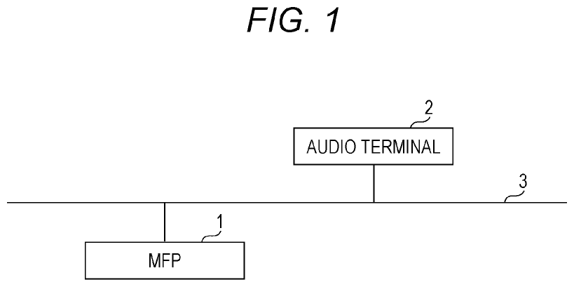

FIG. 1 is a configuration diagram of an image processing system in which an image forming apparatus 1 as an image processor according to one or more embodiments of the present invention is used. This image processing system includes an audio terminal 2 in addition to the image forming apparatus 1, and the image forming apparatus 1 and the audio terminal 2 are connected to each other via a network 3.

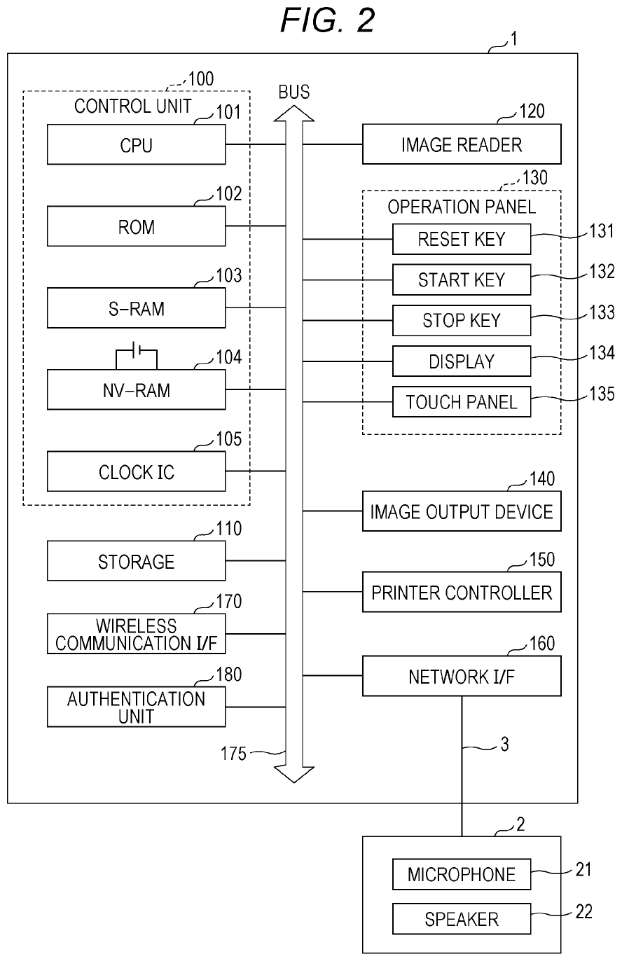

FIG. 2 is a block diagram illustrating configurations of the image forming apparatus 1 and the audio terminal 2 in the image processing system illustrated in FIG. 1. In one or more embodiments, the MFP mentioned above is used as the image forming apparatus 1, which is a multifunctional digital complex machine having a copy function, a printer function, a facsimile function, a scan function, and the like. Hereinafter, the image forming apparatus is also referred to as the MFP.

As illustrated in FIG. 2, an MFP 1 includes a control unit 100, a storage 110, an image reader 120, an operation panel 130, an image output device 140, a printer controller 150, a network interface (network UF) 160, a wireless communication interface (wireless communication UF) 170, an authentication unit 180, and the like, which are connected to each other via a system bus 175.

The control unit 100 includes a central processing unit (CPU) 101, a read-only memory (ROM) 102, a static random access memory (S-RAM) 103, a non-volatile RAM (NV-RAM) 104, a clock IC 105, and the like.

The CPU 101 executes an operation program stored in the ROM 102 or the like, thereby overall controlling the entire MFP 1. For example, the copy function, the printer function, the scan function, the facsimile function, and the like are controlled in an executable manner. Moreover, various kinds of processing are performed in one or more embodiments, such as receiving voice input data from the user input from the audio terminal 2 via the network interface 160 and analyzing the voice input data to set a setting value that is the operation condition of the job instructed to set by the user, transmitting voice output data for causing the audio terminal 2 to output a message for asking the user to confirm that the setting is satisfactory before execution of the job to the audio terminal 2 via the network interface 160, determining whether the default value of the operation condition of the job has been changed, and changing contents of the message on the basis of a result of the determination. Details will be described later.

The ROM 102 stores a program to be executed by the CPU 101 and other data.

The S-RAM 103 serves as a work area at the time when the CPU 101 executes a program, and temporarily stores a program, data at the time of executing the program, and the like.

The NV-RAM 104 is a non-volatile memory backed up by a battery, and stores various settings related to image formation, and the like.

The clock IC 105 clocks the time, and functions as an internal timer to measure processing time, and the like.

The storage 110 is composed of a hard disk or the like, and stores a program, various data, and the like. In particular, default values of operation conditions for executing various jobs, such as a copy job, a print job, a facsimile transmission job, and a scan job, are stored in one or more embodiments. When the default value is changed to another setting value or when the changed setting value is further changed, changed content including the changed setting value is stored in the storage 110. However, in one or more embodiments, the content is overwritten by the latest changed content including the latest setting value, whereby only the latest changed content is retained.

The image reader 120 includes a scanner and the like, which scans a document set on platen glass to read the document and converts the read document into image data.

The operation panel 130 is used when the user issues an instruction about a job or the like or performs various settings on the MFP 1, and includes a reset key 131, a start key 132, a stop key 133, a display 134, a touch panel 135, and the like.

The reset key 131 is used for resetting the setting, the start key 132 is used for starting operation of scanning or the like, and the stop key 133 is pressed for interrupting operation or the like.

The display 134 is composed of, for example, a liquid crystal display, and displays a message, various operation screens, and the like. The touch panel 135 is formed on the screen of the display 134, and detects touch operation made by the user.

The image output device 140 prints the image data of the document read by the image reader 120 and a copy image generated from print data transmitted from a terminal 3 on a paper sheets, and outputs them as printed matters.

The printer controller 150 generates a copy image data from the print data received by the network interface 160.

The network I/F 160 functions as a communication unit that exchanges data with an external device such as the audio terminal 2 mentioned above via the network 3, and the wireless communication I/F 170 is an interface for communicating with the external device using short-range wireless communication.

The authentication unit 180 obtains authentication information of the user who logs in, and compares the authentication information with information for verification stored in the fixed storage 110 or the like in advance, thereby performing authentication. Note that the information for user authentication may be compared with the information for verification using an external authentication server, and the authentication unit 180 may receive a result of the authentication from the authentication server to perform authentication.

The audio terminal 2 includes a microphone 21 that functions as a voice input device, and a speaker 22 that functions as a voice output device. The microphone 21 transmits input voice data to the MFP 1 via the network 3, and the speaker 22 outputs (utters) the voice data transmitted from the MFP 1 via the network 3 as voice.

Although the user's voice input to the microphone 21 of the audio terminal 2 is analyzed by the MFP 1, it may be analyzed as a keyword or the like by an external device such as an analysis server (not illustrated), and the MFP 1 may receive and accept data of a result of the analysis from the analysis server.

Next, operation of an MFP 1 at the time when a user instructs, via an audio terminal 2, the MFP 1 to execute a job by voice will be described in accordance with one or more embodiments of the present invention.

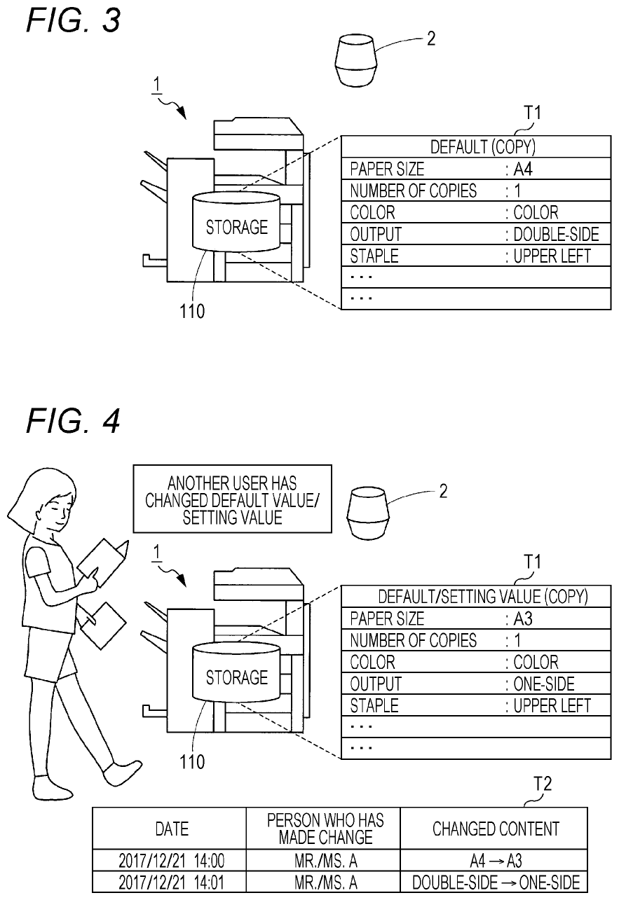

As illustrated in a table T1 in FIG. 3, default values regarding a job and an operation condition of the job are stored in a storage 110 of the MFP 1 in advance by an administrator or the like, for example. In the example of FIG. 3, a copy job is set as a default job. Therefore, unless the user specifies a type of the job by voice, the copy job is executed.

In addition, for example, a paper size: A4, the number of copies: 1, a color mode: color, output: double-side, and a (position of) staple: upper left are set in advance as default values of the operation conditions of the copy job.

In that state, the administrator or another user may change at least one default value among one or a plurality of default values mentioned above, or may further change the changed setting value to still another setting value. In that case, the default value is overwritten by the changed setting value as illustrated in the table T1 in FIG. 4, and furthermore, the date and time of the change, a person who has made the change, and the changed content are stored as illustrated in a table T2. In the example illustrated in FIG. 4, the paper size is changed from A4, which is the default value, to A3, and the output is changed from the double-side, which is the default value, to one-side. Accordingly, the CPU 101 of the control unit 100 can recognize that the A4 size, which is the default value, is currently changed to the A3 size.

When the same user or another user further changes the paper size from A3, which is the changed setting value, to B4, for example, the item of the table T1 in FIG. 4 is overwritten by B4, the date and the person who has made the change in the upper row of the table T2 are overwritten, and further, the item of the changed content “A4→B4” is overwritten.

In this manner, when the default value is changed a plurality of times, the changed content is overwritten so that only the latest changed content is stored and retained in the storage 110, whereby the amount of use of the storage area in the storage 110 can be minimized compared with a case where all pieces of changed content are stored.

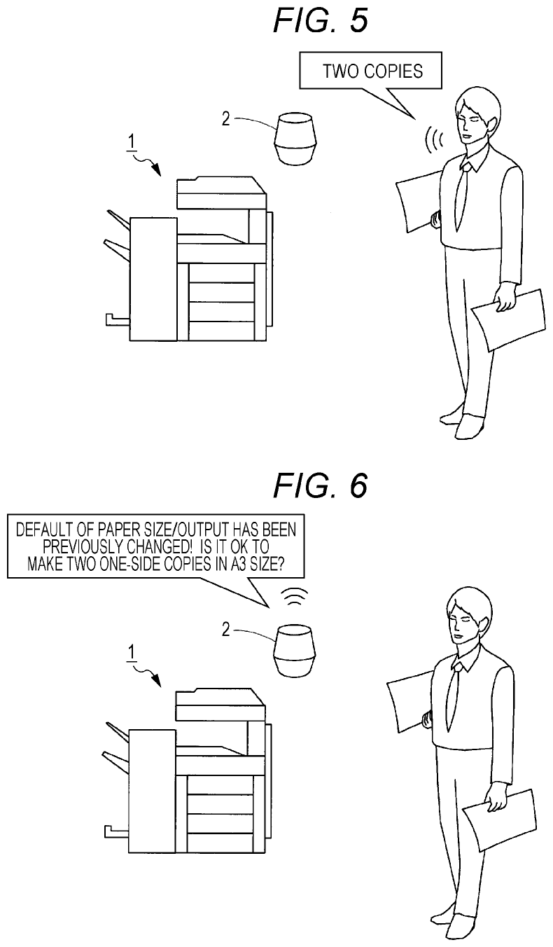

Thereafter, when another user executes a copy job without knowing that the default value has been changed, an instruction for setting an operation condition “Two copies.” is assumed to be issued by voice input from the microphone 21 of the audio terminal 2, as illustrated in FIG. 5.

Conventionally, although the MFP 1 outputs a confirmation voice message such as “Is it OK to make two copies?” via the speaker 22 of the audio terminal 2, the user is not notified of the fact that the default value has been changed. Accordingly, the copy job is started when the user performs voice input for instructing execution of the job, such as “Yes”, in response to the confirmation message. However, while the user expects copying with the default value other than the setting instructed by himself/herself, the copy job is executed with the setting value different from the default value, whereby erroneous copying or the like occurs.

In view of the above, in one or more embodiments, when the default value has been changed, the speaker 22 of the audio terminal 2 outputs, before execution of the copy job, voice to notify the user of a confirmation message including the changed content of the default value along with the content of the setting instruction input by the user's voice.

Examples of the confirmation message include, as illustrated in FIG. 6, a message “The default of the paper size/output has been previously changed. Is it OK to make two one-side copies in the A3 size?”.

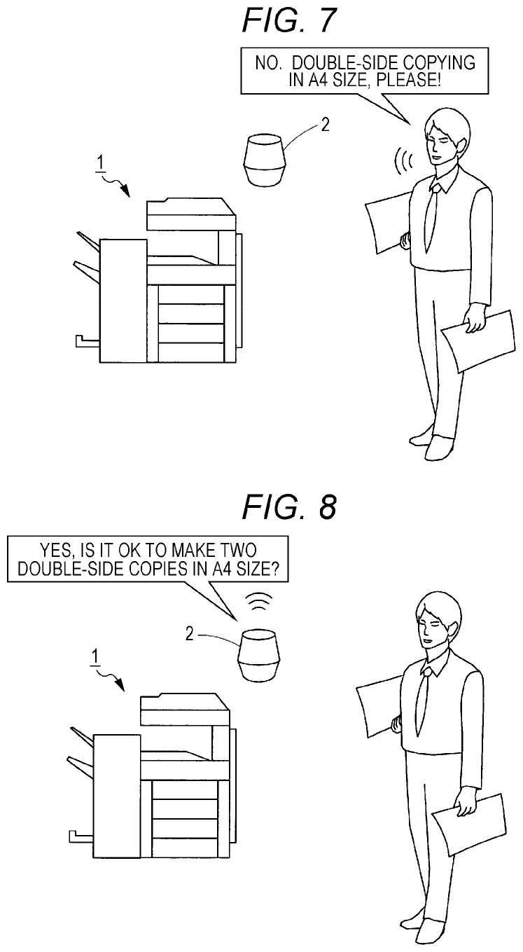

When the user who has heard the message notices the change of the default value and inputs a setting instruction such as “No, double-side copying in the A4 size, please.” by voice again, as exemplified in FIG. 7, the MFP 1 accepts the setting instruction and reflect it in the setting. As illustrated in FIG. 8, in order to confirm the reflected setting content again, it causes the speaker 22 of the audio terminal 2 to output a confirmation message by voice, such as “Yes, is it OK to make two double-side copies in the A4 size?”.

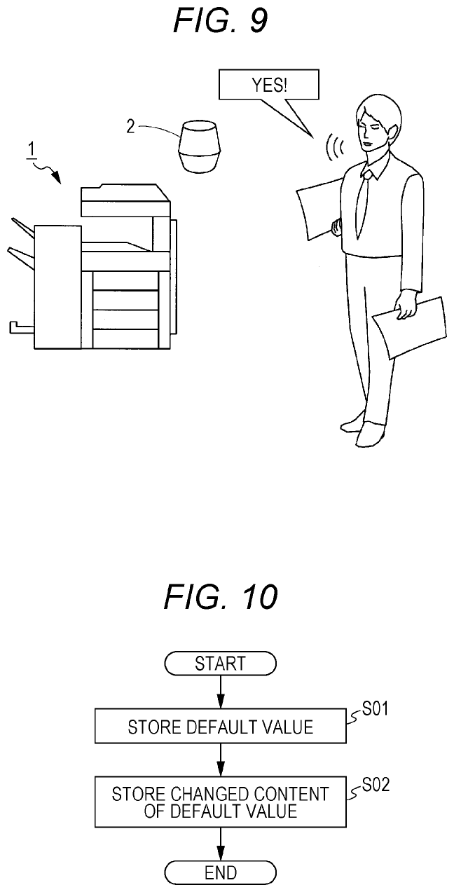

Upon reception of the message, the user inputs voice, such as “Yes” illustrated in FIG. 9, for instructing execution of the job when the setting content indicated by the message is satisfactory. The MFP 1 receives the voice input, and assumes that the final confirmation from the user is obtained, thereby starting the copy job.

As described above, in one or more embodiments, when the default value has been changed, a confirmation voice message including the changed content of the default value is output, whereby the user can recognize that the default value has been changed. Therefore, when the changed setting value is not the intended value, the user can change the setting value again, whereby the inconvenience in which the copy job is executed while the user does not notice the change of the default value so that erroneous copying occurs can be eliminated.

When the user issues the setting instruction for changing the default value, even if the default value has already been changed, a message including only the content of the setting instruction from the user, not including the changed content of the default value, is output from the audio terminal 2. For example, in the case where the default value of the paper size is A4, the administrator, another user, or the like has changed the default value to A3, and then the user inputs a voice instruction for setting the B4 size, the user is not notified of the fact that the default value is changed from A4 to A3. This is because such notification is useless.

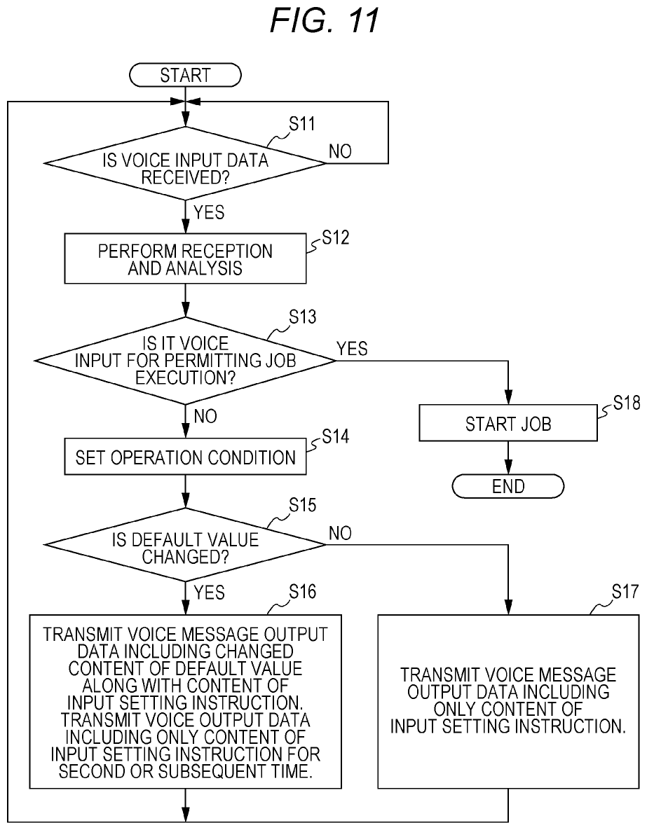

FIG. 10 is a flowchart illustrating a process of storing a default value performed by the MFP 1. Operation illustrated in this flowchart and flowcharts after FIG. 11 are executed by the CPU 101 included in the control unit 100 of the MFP 1 operating in accordance with the operation program stored in a recording medium such as the ROM 102.

In step S01, a default value is stored in the storage 110 in accordance with operation of the administrator or the like. When the default value is changed, the changed content is stored in step S02.

FIG. 11 is a flowchart illustrating operation of the MFP 1 that has received the instruction for setting the operation condition of the job made by the user's voice as described above.

In step S11, it is determined whether voice input data made by the user is received via the microphone 21 of the audio terminal 2. When it is not received (NO in step S11), it waits until it receives the voice input data.

When it is received (YES in step S11), it is accepted and analyzed in step S12, and it is determined whether the voice input is for permitting execution of the job, such as “Yes” and “OK”, in step S13. When it is not the voice input for permitting execution of the job (NO in step S13), it is the setting instruction of the operation condition, and the operation condition (setting value) corresponding to the voice input is set in step S14.

Next, in step S15, it is determined whether the default value has been changed. When it has been changed (YES in step S15), in step S16, voice message output data including the changed content of the default value along with the content of the input setting instruction is generated to be transmitted to the audio terminal 2, and the process returns to step S01.

The audio terminal 2 outputs voice of data for voice output via the speaker 22. For example, in the case of the voice input of “Two copies.”, when the paper size is changed from the default value of A4 to A3, and the default value of double-side output is changed to one-side output, a confirmation message such as “The default value of the paper size/output has been previously changed. Is it OK to make two one-side copies in the A3 size?” is uttered.

When the user who has heard the message notices that the setting is different from his/her intention and inputs “No, double-side copying in the A4 size, please.”, for example, the MFP 1 receives the voice data in step S11, performs reception and analysis in step S12, performs determination in step S13, and then changes the settings of the paper size and the output to A4 and the double-side output in step S14.

Next, in step S15, it is determined whether the default value has been changed. Here, since it has already notified the user that the default value has been changed in response to the first voice input, the change is ignored for the second or subsequent time, and voice message output data including only the content of the input setting instruction is transmitted to the audio terminal 2 in step S16. As a result, a confirmation message such as “Yes, is it OK to make two double-side copies in the A4 size?” is uttered from the speaker 22 of the audio terminal 2.

When the notified operation condition is satisfactory, the user inputs voice for permitting execution of the job, such as “Yes” and “OK”. The MFP 1 receives the voice data in step S11, accepts and analyzes the data in step S12, and determines whether the voice input is for permitting execution of the job in step S13. When it is the voice input for permitting execution of the job (YES in step S13), the process proceeds to step S18, and the job is started.

When the default value has not been changed in step S15 (NO in step S15), in step S17, voice output data of a message including only the content of the input setting instruction (e.g., “Is it OK to make two copies?” in response to the voice input “Two copies.”) is generated, and is transmitted to the audio terminal 2.

When the user issues the setting instruction for changing the default value, even if the default value is determined to have been changed in step S15, a message including only the content of the setting instruction from the user, not including the changed content of the default value, is output from the audio terminal 2. This can eliminate unnecessary notification.

In one or more embodiments, when an MFP 1 is in a state in which at least one default value cannot be used due to its own device state, a message including content that cannot use the default value is output from an audio terminal 2.

To describe a specific example, default values regarding a job and an operation condition of the job are stored in a storage 110 of the MFP 1 in advance by an administrator or the like, for example. In this example, in a similar manner to the table T1 in FIG. 3, a copy job is set as a default job, and as default values of the operation conditions of the copy job, for example, a paper size: A4, the number of copies: 1, a color mode: color, output: double-side, and a (position of) staple: upper left are set in advance.

Here, there may be a case where at least one default value among the preset one or more default values cannot be used due to the state of the MFP 1. For example, there may be a case where, while the default value of the paper size is A4, A4 paper sheets stored in a paper feed tray have run out, or a case where paper sheets of another size are stored in the paper feed tray. In addition, there may be a case where at least one of toners of respective colors has run out, a case where staples have run out while a stapling process on an upper left portion of a paper sheet is set as a default value in a post-processing apparatus, and the like. Hereinafter, an exemplary case where A4 paper sheets in the paper feed tray have run out will be described.

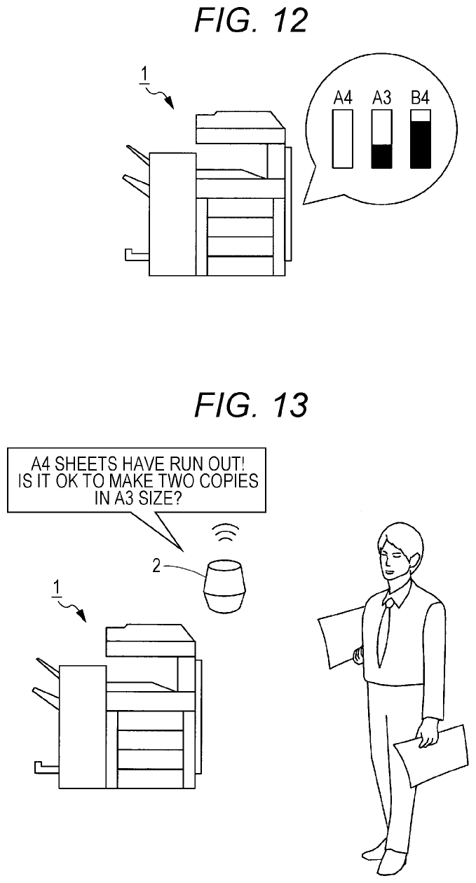

FIG. 12 illustrates the remaining numbers of three sizes of paper sheets, A4, A3, and B4, stored in paper feed trays using height of black-painted portions, and illustrates that the remaining number of A4 paper sheets, which is the default value of the paper size of the copy job, is zero.

In this state, it is assumed that, in a similar manner to the case of FIG. 5, a user has issued an instruction for setting an operation condition by voice input “Two copies.” via a microphone 21 of the audio terminal 2 without knowing that no A4 paper sheet is stored for execution of the copy job.

Conventionally, although the MFP 1 outputs a confirmation voice message such as “Is it OK to make two copies?” via a speaker 22 of the audio terminal 2, the user is not notified of the fact that an A4 paper sheet, which is the default value, cannot be used. Accordingly, the copy job is started when the user performs voice input for instructing execution of the job, such as “Yes”, in response to the confirmation message. However, while the user expects copying with the default value other than the setting instructed by himself/herself, the copy job is executed with the setting value different from the default value, such as an A3 paper sheet, whereby erroneous copying or the like occurs.

In view of the above, in one or more embodiments, when the default value cannot be used, the speaker 22 of the audio terminal 2 outputs, before execution of the copy job, voice to notify the user of a confirmation message including the fact that the default value cannot be used, that is, the content that A4 paper sheets cannot be used in this example, along with the content of the setting instruction input by the user's voice.

Examples of the confirmation message include “A4 sheets have run out. Is it OK to make two copies in the A3 size?” as illustrated in FIG. 13.

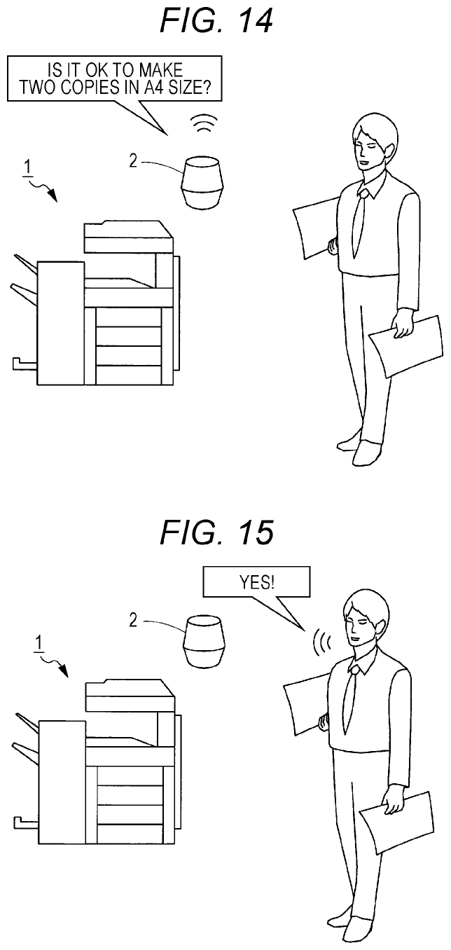

It is assumed that the user who has heard this message notices that the A4 paper sheets, which is the default value, cannot be used and A4 paper sheets have been supplied to the paper feed tray. Then, the MFP 1 determines that the paper sheets have become available, and outputs a voice message reflecting the default value (A4) that has become available along with the content of the input setting instruction (two copies), such as “Is it OK to make two copies in the A4 size?” as illustrated in FIG. 14, via the audio terminal 2.

Upon reception of the message, the user inputs voice, such as “Yes” illustrated in FIG. 15, for instructing execution of the job when the setting content indicated by the message is satisfactory. The MFP 1 receives the voice input, and assumes that the final confirmation from the user is obtained, thereby starting the copy job.

In this manner, according to one or more embodiments, the confirmation voice message including the content of unavailability of the default value is output when the default value cannot be used due to the state of the MFP 1, whereby the user can recognize that the default value cannot be used and take measures to address the state in which the default value cannot be used, such as paper supply. As a result, the inconvenience in which the user cannot obtain the intended execution result of the job can be eliminated.

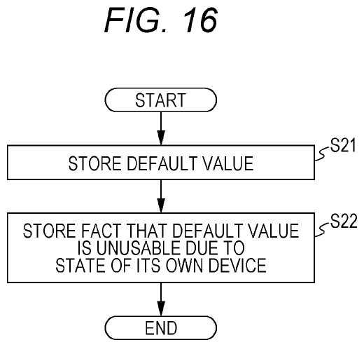

FIG. 16 is a flowchart illustrating a process of storing a default value performed by the MFP 1.

In step S21, a default value is stored in the storage 110 in accordance with operation of the administrator or the like. In step S22, the fact that the default value cannot be used due to the state of its own device is stored.

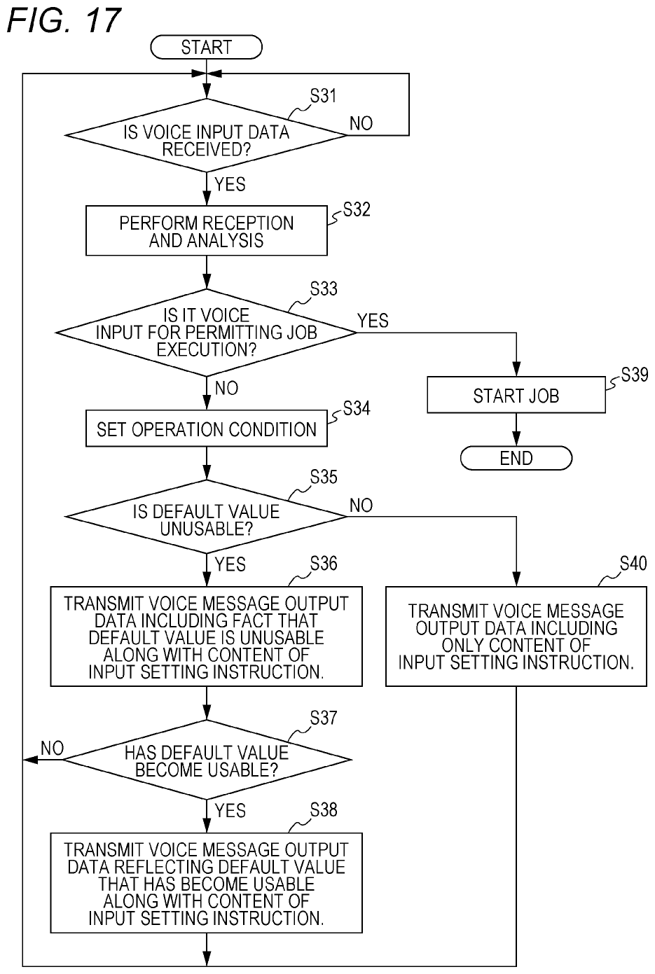

FIG. 17 is a flowchart illustrating operation of the MFP 1 that has received the instruction for setting the operation condition of the job made by the user's voice.

In step S31, it is determined whether voice input data made by the user is received via the microphone 21 of the audio terminal 2. When it is not received (NO in step S31), it waits until it receives the voice input data.

When it is received (YES in step S31), it is accepted and analyzed in step S32, and it is determined whether the voice input is for permitting execution of the job, such as “Yes” and “OK”, in step S33. When it is not the voice input for permitting execution of the job (NO in step S33), it is the setting instruction of the operation condition, and the operation condition (setting value) corresponding to the voice input is set in step S34.

Next, in step S35, it is determined whether the default value cannot be used due to the state of its own device. When it cannot be used (YES in step S35), in step S36, voice message output data including the content of unavailability of the default value along with the content of the input setting instruction is generated, and is transmitted to the audio terminal 2. Examples of the message include “A4 sheets have run out. Is it OK to make two copies in the A3 size?”.

Next, in step S37, it is determined whether the default value has become usable, and when it has not become usable (NO in step S37), the process returns to step S31. When the user who has heard the message in step S36 notices that the default value cannot be used and the cause of the unavailability has been resolved, such as paper supply, the default value becomes usable (YES in step S37). In this case, in step S38, voice message output data reflecting the default value that has become usable along with the content of the input setting instruction is transmitted to the audio terminal 2, and then the process returns to step S31. Examples of the message include “Is it OK to make two copies in the A4 size?”.

When the notified operation condition is satisfactory for the user who has heard the message, the user inputs voice for permitting execution of the job, such as “Yes” and “OK”. The MFP 1 receives the voice data in step S31, accepts and analyzes the data in step S32, and determines whether the voice input is for permitting execution of the job in step S33. When it is the voice input for permitting execution of the job (YES in step S33), the process proceeds to step S39, and the job is started.

When the default value is usable in step S35 (NO in step S35), in step S40, voice output data of a message including only the content of the input setting instruction (e.g., “Is it OK to make two copies?” in response to the voice input “Two copies.”) is generated, and is transmitted to the audio terminal 2.

Although the embodiments of the present invention have been described above, the present invention is not limited to the embodiments described above.

For example, although the case where default values common to all users are set and store in the storage 110 has been described in one or more embodiments described above, default values may be set for each user. In that case, the default value corresponding to the logged-in user authenticated by the authentication unit 180 is applied, and it is determined whether the default value has been changed or whether the default value cannot be used due to the state of the MFP 1 corresponding to the logged-in user.

Further, although the exemplary case where the audio terminal 2 is composed of an external device different from the MFP 1 has been described, at least one of the microphone 21 and the speaker 22 of the audio terminal 2 may be included in the MFP 1.

Furthermore, although the case where the image processor is the MFP has been described, it may be another image processor as long as operation conditions can be set by a setting instruction made by the user's voice.

According to one or more embodiments of the present invention, when the user issues an instruction for setting an operation condition of a job by voice via a voice input device capable of inputting voice, the instruction is received, and the operation condition of the job is set in accordance with the received instruction for setting the operation condition of the job. Before execution of the job, a confirmation voice message including content of the received instruction for setting the operation condition of the job is output from a voice output device. A storage stores one or a plurality of default values regarding the operation condition of the job, and when at least one of the default values is changed, the changed content is also stored in the storage.

Then, before the execution of the job, it is determined whether the default value has been changed. When it is determined to have been changed, a message including the changed content of the default value is output from the voice output device.

In this manner, when the default value has been changed, the voice message including the changed content of the default value is output, whereby the user can recognize that the default value has been changed. Therefore, when the changed setting value is not the intended value, the user can change the setting value again, whereby it is possible to eliminate the inconvenience in which the job is executed while the user does not notice the change of the default value so that the intended job execution result cannot be obtained.

According to one or more embodiments of the present invention, when the default value cannot be used due to a state of its own device, a message including content that the default value cannot be used is output from the voice output device, whereby the user can recognize, for example, a state in which the default value of an A4 paper sheet cannot be used due to lack of the A4 paper sheet in a paper feed tray, and can take measures to address the state in which the default value cannot be used. As a result, the inconvenience in which the user cannot obtain the intended execution result of the job can be eliminated.

According to one or more embodiments of the present invention, when the received instruction for setting the operation condition of the job is a setting instruction for changing at least one of the default values, the message is output without including the changed content of the default value even if the default value has already been changed. Accordingly, unnecessary notification to the user can be eliminated.

According to one or more embodiments of the present invention, when the default value is changed a plurality of times, the changed content is overwritten so that the storage stores only the latest changed content, whereby the amount of use of the storage area in the storage can be reduced compared with a case where all pieces of changed content are stored.

According to one or more embodiments of the present invention, when the user issues an instruction for changing the setting value changed from the default value to an initial default value by voice after the voice output device outputs a first message, and a setter changes the setting value to the initial default value in accordance with the setting instruction, since the default value has been changed on the basis of the intention of the user, the message not including the changed content of the default value is output even if the user issues an instruction for setting the job operation condition concerning the job. Accordingly, unnecessary notification to the user can be eliminated.

According to one or more embodiments of the present invention, when the state in which the default value cannot be used due to the state of its own device is canceled, the voice output device outputs the message reflecting the default value that has become usable, whereby the user can recognize that the default value has become usable.

According to one or more embodiments of the present invention, the default value is stored for each user, and it is determined for each user whether the default value has been changed, and it is also determined for each user whether or not to output a voice message, whereby a use form can be set for each user.

According to one or more embodiments of the present invention, at least one of the voice input device and the voice output device can be composed of an external device other than its own device.

According to one or more embodiments of the present invention, it is possible to cause a computer of an image processor to execute a process including receiving an instruction for setting the operation condition of the job issued by the user's voice via the voice input device capable of inputting voice, setting the operation condition of the job in accordance with the setting instruction, determining whether at least one of the default values has been changed, and when it is determined to have been changed, causing the voice output device to output the message including the changed content of the default value.

According to one or more embodiments of the present invention, it is possible to cause the computer of the image processor to execute a process including receiving the instruction for setting the operation condition of the job issued by the user's voice via the voice input device capable of inputting voice, setting the operation condition of the job in accordance with the setting instruction, determining whether at least one of the default values cannot be used due to the state of its own device, and when it is determined to be in the unusable state, causing the voice output device to output the message including the content that the default value cannot be used.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image processor comprising:
a hardware processor that:
receives an instruction for setting an operation condition of a job issued by voice of a user via a voice input device; and
sets the operation condition of the job based on the instruction; and
a storage that stores:
one or more default values regarding the operation condition of the job, and
a changed content when at least one of the default values is changed,
wherein the hardware processor further:
causes, before execution of the job, a voice output device to output a voice confirmation message that includes a content of the instruction;
determines, before the execution of the job, whether at least one of the default values is changed; and
causes, when a default value among the one or more default values is changed, the voice output device to output the changed content of the default value in the voice confirmation message.

2. An image processor comprising:
a hardware processor that:
receives an instruction for setting an operation condition of a job issued by voice of a user via a voice input device; and
sets the operation condition of the job based on the instruction; and
a storage that stores one or more default values regarding the operation condition of the job,
wherein the hardware processor further:
causes, before execution of the job, a voice output device to output a voice confirmation message that includes a content of the instruction;
determines, before the execution of the job, whether at least one of the default values cannot be used due to a state of the image processor; and
causes, when a default value among the one or more default values cannot be used due to the state of the image processor, the voice output device to output information that the default value cannot be used in the voice confirmation message.

3. The image processor according to claim 1, wherein when the instruction is a setting instruction for changing at least one of the default values, the hardware processor further causes the voice output device to output, even when the default value has already been changed, the voice confirmation message without the changed content of the default value.

4. The image processor according to claim 1, wherein when the default value is changed a plurality of times, the storage overwrites the changed content to store only a latest changed content.

5. The image processor according to claim 1, wherein when the user issues an instruction for changing a setting value from the default value to an initial default value by voice after the voice output device outputs the voice confirmation message and the hardware processor changes the setting value to the initial default value based on the setting instruction, the hardware processor further causes the voice output device to output the voice confirmation message without the changed content even when the user issues the instruction for setting the operation condition of the job after the setting value is changed to the initial default value.

6. The image processor according to claim 2, wherein when the state of the image processor is canceled, the hardware processor further causes the voice output device to output the default value that has become usable in the voice confirmation message.

7. The image processor according to claim 1, wherein the default values are set for each user and the storage stores the default values set with each user.

8. The image processor according to claim 1, wherein at least one of the voice input device and the voice output device includes an external device other than the image processor.

9. A non-transitory recording medium that stores a computer readable program that causes a computer of an image processor that includes a storage that stores one or more default values regarding an operation condition of a job to:
receive an instruction for setting the operation condition of the job issued by voice of a user via a voice input device;
set the operation condition of the job based on the received instruction;
store changed content in the storage when at least one of the default values is changed;
cause a voice output device to output, before execution of the job, a voice confirmation message that includes a content of the received instruction;
determine whether at least one of the default values is changed before the execution of the job; and
when a default value among the one or more default values is determined to be changed, cause the voice output device to output the changed content of the default value in the voice confirmation message.

10. A non-transitory recording medium that stores a computer readable program that causes a computer of an image processor that includes a storage that stores one or more default values regarding an operation condition of a job to:
receive an instruction for setting the operation condition of the job issued by voice of a user via a voice input device;
set the operation condition of the job based on the received instruction;
cause a voice output device to output, before execution of the job, a voice confirmation message that includes a content of the received instruction;
determine, before the execution of the job, whether at least one of the default values cannot be used due to a state of the image processor; and
when a default value among the one or more default values is determined to be unusable, cause the voice output device to output information that the default value cannot be used in the voice confirmation message.

11. The image processor according to claim 2, wherein the default values are set for each user and the storage stores the default values set with each user.

12. The image processor according to claim 2, wherein at least one of the voice input device and the voice output device includes an external device other than the image processor.
